(19) United States
(12) Patent Application Publication
(10) Pub. No.: US 2026/0099148 A1
(43) Pub. Date: Apr. 9, 2026

(54) REAL-TIME MULTI-ROBOT COLLABORATION IN DYNAMIC ENVIRONMENTS

(71) Applicant: Field AI, Inc., Mission Viejo, CA (US)

(72) Inventors: Shayegan OMIDSHAFIEI, Dorchester, MA (US); Sung Kyun KIM, Irvine, CA (US); Aliakbar AGHAMOHAMMADI, Mission Viejo, CA (US); David FAN, Lake Forest, CA (US); Dong Ki KIM, Cambridge, MA (US)

(73) Assignee: Field AI, Inc., Mission Viejo, CA (US)

(21) Appl. No.: 19/352,764

(22) Filed: Oct. 8, 2025

Related U.S. Application Data
(60) Provisional application No. 63/705,077, filed on Oct. 9, 2024.

(51) Int. Cl. G05D 1/246; G05D 1/698; G05D 101/10

(52) U.S. Cl. CPC G05D 1/2462; G05D 1/6983; G05D 2101/10

(57) ABSTRACT

Systems and methods for performing real-time multi-robot collaboration in dynamic environments are provided. A system may obtain sensor data of an environment of the robot, and generate tokenized sensor data from the sensor data. The system may input the tokenized sensor data into a robotics foundational model (RFM) associated with the robot causing the RFM to generate insight data used for making decisions associated with performing the mission. Generating the insight data includes generating one or more beliefs about the environment and generating one or more risk-reward maps indicating potential risks and/or a. The system implement a token sharing policy causing the robot to generate tokenized insight data and transmit the tokenized insight data to recipient robots of the robot fleet.

### CROSS-REFERENCE TO RELATED APPLICATION

This application claims priority to and the benefit of the filing date of provisional U.S. patent application Ser. No. 63/505,077, entitled “SYSTEM AND METHOD FOR REAL-TIME MULTI-ROBOT COLLABORATION IN DYNAMIC ENVIRONMENTS” and filed on Oct. 9, 2024, the entire contents of which is hereby expressly incorporated herein by reference.

### TECHNICAL FIELD

The implementations of the present disclosure relate to multi-robot systems, and specifically to systems and methods for performing real-time multi-robot collaboration in dynamic environments.

### BACKGROUND

Multi-robot systems have gained significant attention in recent years due to their potential for enhanced efficiency and capability in various applications. The multi-robot systems involve multiple robots (e.g., a fleet of autonomous robots) working together to accomplish complex tasks (e.g., a mission) that may be difficult or impossible for a single robot to perform alone. However, coordinating multiple robots effectively while ensuring safety and optimal performance remains a challenging technical problem in robotics.

Traditional approaches to multi-robot coordination rely on centralized control systems or predefined rules for robot behavior. While the traditional approaches may be effective in controlled environments, the traditional approaches struggle to adapt to dynamic and uncertain real-world scenarios and environments. Additionally, the centralized control systems may suffer from scalability issues and single points of failure, limiting applicability of the centralized control systems in large-scale deployments.

Another common approach in the multi-robot systems is the use of distributed algorithms, where robots make decisions based on local information and limited communication with nearby robots. While such an approach may improve the scalability and robustness, it can detrimentally lead to suboptimal global performance of the robot fleet due to the limited information available to each robot.

Existing multi-robot systems struggle with heterogeneity, as the existing multi-robot systems are designed robots with similar capabilities and sensory inputs. This limitation restricts the flexibility and adaptability of the existing multi-robot systems in real-world applications where diverse robot types may be required to accomplish complex missions.

Current approaches to risk assessment and safety in the multi-robot systems are based on simplistic models or heuristics, which may not adequately capture the complexities of the real-world environments. This may lead to overly conservative behavior or, conversely, unsafe operations in critical situations.

The sharing of information between robots in existing multi-robot systems is limited to basic state information or simple observations. This restricts the ability of robots to benefit from the collective knowledge and experiences of entire fleet, potentially leading to inefficient or suboptimal decision-making.

In sum, existing procedural generation testing techniques lack the flexibility and creativity to systematically target robotic weaknesses, progressively increase complexity, effectively evaluate the robustness and safety of robot fleets in real-world conditions, and provide insights for continuous improving and refining robots. In light of these technical limitations, there exists a clear need for a technical solution to perform real-time multi-robot collaboration in dynamic environments.

### SUMMARY

In one general aspect, the instant disclosure describes a system for performing real-time multi-robot collaboration in dynamic environments. The system may include one or more processors; and one or more memories having stored thereon processor-executable instructions that, when executed by the one or more processors, cause the one or more processors to perform operations of: obtaining, from sensors of a robot of a robot fleet, sensor data of an environment of the robot, wherein the robot fleet is configured to perform a mission in the environment that is unknown to the robot fleet; generating tokenized sensor data by tokenizing the sensor data; inputting the tokenized sensor data into a robotics foundational model (RFM) associated with the robot causing the RFM to generate insight data used for making decisions associated with performing the mission, wherein generating the insight data includes: generating, via a belief model based upon the tokenized sensor data, belief data indicating one or more beliefs about the environment, wherein the belief data indicates a portion of the environment associated with a belief and a confidence metric associated with the belief; and generating one or more risk-reward maps, each risk-reward map indicating one or more of a potential risk or a potential reward associated with the robot performing the mission, wherein the insight data includes the belief data and the one or more risk-reward maps; and implementing a token sharing policy causing the robot to perform: generating tokenized insight data by tokenizing the insight data; and transmitting the tokenized insight data to one or more recipient robots of the robot fleet.

In another general aspect, the instant disclosure describes a computer-implemented method for performing real-time multi-robot collaboration in dynamic environments. The computer-implemented method may include obtaining, by one or more processors from sensors of a robot of a robot fleet, sensor data of an environment of the robot, wherein the robot fleet is configured to perform a mission in the environment that is unknown to the robot fleet; generating, via the one or more processors, tokenized sensor data by tokenizing the sensor data; inputting, by the one or more processors, the tokenized sensor data into a robotics foundational model (RFM) associated with the robot causing the RFM to generate insight data used for making decisions associated with performing the mission, wherein generating the insight data includes: generating, by the one or more processors via a belief model based upon the tokenized sensor data, belief data indicating one or more beliefs about the environment, wherein the belief data indicates a portion of the environment associated with a belief and a confidence metric associated with the belief; and generating, by the one or more processors, one or more risk-reward maps, each risk-reward map indicating one or more of a potential risk or a potential reward associated with the robot performing the mission, wherein the insight data includes the belief data and the one or more risk-reward maps; and implementing a token sharing policy causing the robot to perform: generating, by the one or more processors, tokenized insight data by tokenizing the insight data; and transmitting, by the one or more processors, the tokenized insight data to one or more recipient robots of the robot fleet.

In another general aspect, the instant disclosure describes a non-transitory computer-readable medium storing processor-executable instructions that, when executed by one or more processors, may cause the one or more processors to at least: obtain, from sensors of a robot of a robot fleet, sensor data of an environment of the robot, wherein the robot fleet is configured to perform a mission in the environment that is unknown to the robot fleet; generate tokenized sensor data by tokenizing the sensor data; input the tokenized sensor data into a robotics foundational model (RFM) associated with the robot causing the RFM to generate insight data used for making decisions associated with performing the mission, wherein generating the insight data includes: generating, via a belief model based upon the tokenized sensor data, belief data indicating one or more beliefs about the environment, wherein the belief data indicates a portion of the environment associated with a belief and a confidence metric associated with the belief; and generating one or more risk-reward maps, each risk-reward map indicating one or more of a potential risk or a potential reward associated with the robot performing the mission, wherein the insight data includes the belief data and the one or more risk-reward maps; and implement a token sharing policy causing the robot to perform: generating tokenized insight data by tokenizing the insight data; and transmitting the tokenized insight data to one or more recipient robots of the robot fleet.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of an example workflow for performing real-time multi-robot collaboration, in one implementation of the instant application.

FIG. 2 depicts an example environment performing example real-time multi-robot collaboration, in one implementation of the instant application.

FIG. 3 depicts an example risk-reward map associated with the environment of FIG. 2, in one implementation of the instant application.

FIG. 4 is a flow diagram of an example computer-implemented method for performing real-time multi-robot collaboration, in one implementation of the instant application.

FIG. 5 is a block diagram of an example computing environment for performing real-time multi-robot collaboration, in one implementation of the instant application.

FIG. 6 is a block diagram of example subsystems of the computing environment of FIG. 5, in one implementation of the instant application.

FIG. 7 is a block diagram of an example robotics foundation model of the computing environment of FIG. 5, in one implementation of the instant application.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

Conventional systems and methods for performing real-time multi-robot collaboration suffer from several technical problems. Such technical problems include reliance on centralized control systems and/or predefined rules for robot behavior which struggle to adapt to dynamic and uncertain real-world scenarios and suffer from scalability issues and single points of failure, limiting applicability of the centralized control systems in large-scale deployments. Distributed algorithms can lead to suboptimal global performance due to the limited information available to each robot. Existing multi-robot systems struggle with heterogeneity that restrict the flexibility and adaptability of the existing multi-robot systems in real-world applications where diverse robot types may be required to accomplish complex missions. Simplistic models and/or heuristics may not adequately capture the complexities of the real-world environments, leading to overly conservative robot behavior and/or unsafe operations in critical situations. Information sharing between the robots in the existing multi-robot systems can be limited to basic state information or simple observations, restricting the ability of the robots to benefit from the collective knowledge and experiences of entire team, potentially leading to inefficient or suboptimal decision-making. The disclosed techniques implement risk-averse robotics foundational models (RFMs) that dynamically adapt robot performance based upon shared data among a robot fleet. Select, tokenized information (e.g., compressed information) may be shared among a fleet using various transmission methods (e.g., mesh networking, device to device) so that information is cohesive, and up-to-date for the fleet. Decisions of each robot can be made based upon shared information in a manner that best suits the particular robot and its capabilities. The disclosed systems and methods provide a multi-robot collaboration framework that provides at least these advantages, improvements, and/or otherwise technical solutions to the aforementioned technical problems.

The disclosed systems and methods perform real-time multi-robot collaboration in dynamic environments. An example system may obtain sensor data associated with a robot sensing its environment, for example to perform a mission as part of a robot fleet in an unknown environment. The system may generate tokenized sensor data from the sensor data, and input the tokenized sensor data into the RFM associated with the robot. In response the RFM may cause the robot to generate insight data used for making decisions associated with performing the mission. The insight data includes beliefs about the environment and risk-reward maps indicating potential risks and/or rewards associated with performing the mission. The risk-reward maps may include information about the robot generating the insights, such as its pose, location capabilities, reasoning behind the insights, etc. Such information, along with the risk-reward maps and beliefs, can allow a recipient to understand the uniqueness of the information as well as its content. For example, understanding images of the environment were captured by a drone flying overhead to determine a best path of navigation may be crucial if the images are received by a terrestrial robot with different navigational characteristic and decision making criteria than the drone. While such overhead images are useful, understanding their perspective and the robot capturing them may be equally as important to the terrestrial vehicle as what the images depict, so that such information can be processed in the most useful manner to the terrestrial robot.

The system may implement a token sharing policy causing the robot to tokenize the insight data and transmit the tokenized insight data to recipient robots of the robot fleet. Tokenizing the insight data can include performing data compression so that the tokenized insight data provides the technical advantage of requiring fewer computing resources for processing, such as less memory for storing the tokenized insight data, less network bandwidth for transmitting the tokenized insight data, less processing cycles for processing the tokenized insight data, etc. Moreover, the policy can allow a transmitting robot to determine what kinds of information to transmit, and/or which robots to transmit the tokenized information to, allowing further customization of robot collaboration. The recipient robot can then use the received tokenized insight data when making their own decisions affecting performance base upon their unique capabilities, for example to determine whether their own sensor data is more informative for a decision than some of the received tokenized insight data, etc.

The disclosed techniques allow robots in a fleet to dynamically adapt to unexplored environments based upon shared data in a selective manner that conservers computing resources while allowing the recipient robots to analyze the information to arrive at decisions suited to their capabilities. In sum, the disclosed system and methods provide technical advantages and improvements which conventional multi-robot collaboration system and methods do not provide to advance the field of robot collaboration, as just described.

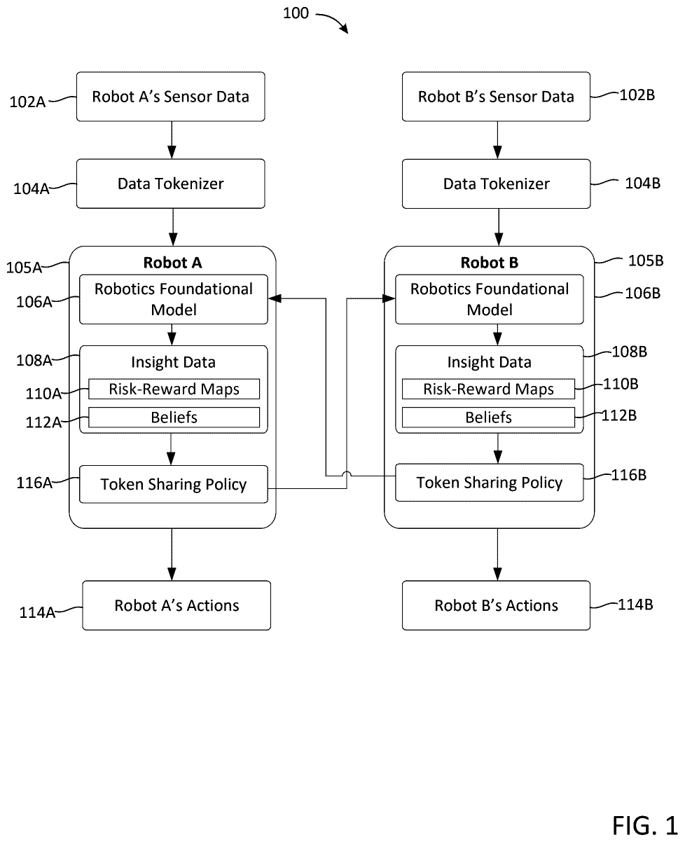

FIG. 1 is a block diagram of an example workflow 100 for performing real-time multi-robot collaboration in dynamic environments, in one implementation of the instant application. The robots of the workflow 100 may include a quadruped, a wheeled robot, a biped, a drone, and/or other suitable robot. The robots may include a fleet of robots disposed in an environment, for example a fleet of robots configured to perform a mission in the environment that is unknown to the robot fleet.

The workflow 100 may include a first robot, referred to as “Robot A” 105, obtaining sensor data 102A via Robot A's sensors, and a second robot, referred to as “Robot B” 105B, obtaining sensor data 102B via Robot B's sensors. A robot may use one or more sensors to sense the unknown environment. The sensors may be in wired (e.g., via a wired communication bus) and/or in wireless (e.g., via a wireless communication network) communication with the robot, for example sensors installed on the root and/or disposed within the environment and in communication with the robots. The sensors may include, but are not restricted to, one or more of imaging sensors (e.g., cameras, Light Detection and Ranging (LIDAR) sound navigation and ranging (SONAR)), navigation sensors (e.g., Global Positioning System (GPS), inertial measurement unit (IMUs), proprioception sensors (e.g., encoders, odometry, actuators), and/or any other suitable sensor. The sensors may generate sensor data indicating detailed information about environment and/or otherwise surrounds of the robot. For example, cameras may generate visual sensor data, the LIDAR sensor may indicate distances between objects via a pulsing laser, etc. The sensors may collectively assist the robots in perceiving the environment in real-time, providing a comprehensive view of obstacles, terrain, and other relevant characteristics of the environment.

The workflow 100 may include a data tokenizer 104A associated with Robot A 105A generating tokenized sensor data by tokening Robot A's sensor data 102A. Robot A 105A may include (e.g., via a local subsystem of Robot A 105A) and/or otherwise implement the data tokenizer 104A. Alternatively, the data tokenizer 104A may be included in the functionality of a respective sensor itself (e.g., a tokenizer of a sensor system on a chip), and/or data tokenization may be provided in any other suitable manner. The workflow 100 may similarly include a data tokenizer 104B associated with Robot B 105B generating tokenized sensor data by tokenizing Robot B's sensor data 102B. Tokening the data, such as the sensor data and/or other data, may include compressing data input into the data tokenizer using one or more data compression techniques (e.g., Lempel-Ziv, encoding, Huffman coding) to reduce its data size. The tokenized data may include one or more tokens each representing at least a portion of the data input into the data tokenizer. For example, particular tokens (e.g., imaging tokens) of tokenized sensor data may be associated with a particular type of sensor data (e.g., image data generated by the camera sensor).

A robot may include a robotics foundational model (RFM). The RFM may provide a general-purpose foundation for robotic perception, reasoning, and action. The functionality of the robot may be implemented, controlled, and/or otherwise provided by the associated RFM. For example, the robot may include a memory storing the RFM that, once executed (e.g., via a processor of the robot), causes the robot to receive sensor data (e.g., tokenized sensor data) as an input, and in response generate output data, such as data associated with insights about the environment based upon the sensor data that is used for decision making and/or otherwise implementing functionality of the robot. The RFM may be based on one or more large-scale machine learning architectures. The RFM may be risk-constrained foundation model configured to ensure safety is a key consideration in the decisions made by the RFM and/or otherwise robots. The risk-constrained RFM may integrate safety constraints (e.g., rules, policies, etc.) into a decision-making process, causing the associated robot to avoid risky actions and prioritize safe behaviors, for example while performing the mission in the environment. Accordingly, the robots of the fleet may operate more reliably in complex and potentially hazardous environments due to the risk-constrained RFM.

The workflow 100 may include providing the tokenized sensor data (e.g., generated by the data tokenizer 104A) as an input to an RFM 106A of Robot A 105A, and in response generating insight data. The insight data may indicate insights of the associated robot (e.g., regarding the environment and/or the robot itself) based upon the sensor data and/or other information used for making decisions by the robot, such as decisions associated with performing the mission. The workflow 100 may similarly include Robot B 105B providing the tokenized sensor data to its RFM 106B to generate associated insight data 108B. A robot may generate associated insight data by causing the associated RFM to implement (e.g., via commands output by the RFM) one or more subsystem, algorithms, rules, models, applications, etc., associated with the robot and/or in communication with the robot.

The insight data 108A, 108B may include and/or otherwise indicate one or more risk-reward maps 110A, 110B and one or more beliefs 112A, 112B of Robot A 105A and Robot B 105B, respectively, associated with the environment. The insight data may indicate other information, such as information associated with the robot generating the insight data including the robot type (e.g., drone, wheeled robot), an internal state of the robot when generating the insight data (e.g., pose, location), an identifier of the robot (e.g., device identification number) and/or any other suitable information. Robot A 105A may perform one or more actions 114A (e.g., actions associated with performing the mission) based upon the insight data 108A, and similarly Robot B 105B may perform one or more actions 114B based upon the associated insight data 108B.

The one or more risk-reward maps may be indicated by risk-reward data. A risk-reward map may indicate for an associated portion of the environment one or more potential risks and/or potential rewards associated with performing different actions by the associated robot, such as actions associated with performing the mission. The risk-reward map may be a visual-based map (e.g., visual depicting risk and/or rewards, such as a heatmap), data-based map (e.g., a matrix with values indicating risk and/or rewards), and/or any other suitable map. The one or more risk-reward maps may include a sematic map (e.g., indicating sematic associations between objects of the environment), a velocity map (e.g., indicating velocity of an object in the environment), a confidence map (e.g., indicating confidence of risk-reward predictions associated with performing an action), a cost map (e.g., indicating a cost associated with performing an action), a risk map (e.g., indicating a risk associated with an action), a reward map (e.g., indicating a reward associated with performing an action), an attention map (e.g., indicating areas of relevance associated with a prediction and/or decisions), and/or other suitable map. The robot may consider one or more of the maps when generating a map, a prediction and/or otherwise belief about a risk and/or reward of the environment. For example, the robot may combine the information of a semantic map, a velocity map, and an attention map to generate the reward map.

One or more beliefs of the robot may be indicated by belief data. The beliefs may include beliefs about the environment. The belief may be associated with and/or otherwise indicate a belief about a pose of the robot in the environment, a type of object in the environment, a location of an object in the environment, a navigation path of the environment, whether a portion of the environment has been explored by the robot fleet, and/or any other suitable belief. The belief data may include and/or otherwise indicate for a belief a portion of the environment associated with a belief (e.g., indicated by a map, environmental coordinates, etc.) and a confidence metric (e.g., rating, ranking, value, etc.). For example, the belief about the location of an object in the environment may indicate an associated location of the object using GPS coordinates provided in associated sensor data by a GPS sensor of the robot, and an associated confidence metric of 0.9 indicating a 90% confidence in the object's location. The confidence metric may be useful to a robot receiving the insight data indicating the beliefs. For example, the recipient robot may use the confidence metric when analyzing, evaluating, and/or weighting one or more insights (e.g., of their own or other robots) when making a decisions. In at least some implementations, generating the beliefs may include calculating probability distributions associated with characteristics of the environment based upon the tokenized sensor data. A belief may be based at least in part upon the probability distributions. For example, the belief about the location of the obstacle may be based upon probability distributions of different types of sensor data (e.g., images, LIDAR point clouds) which each indicate a location of the obstacle.

In at least some implementations, a belief model may generate the belief data based upon receiving sensor data (e.g., tokenized sensor data) as an input. The belief model may include and/or implement one or more models, such as a localization belief model (e.g., to generate beliefs associated with localization of the robot), a mapping belief model (e.g., to generate beliefs associated with a location of the robot), a planning belief model (e.g., to generate beliefs associated with planning tasks of a mission of the robot), and/or any other suitable belief model. In some such implementations, the robot may provide the tokenized sensor data to one or more belief models to generate the beliefs data.

In at least some implementations, the robot (e.g., via its respective RFM) may cause a map generating subsystem as further described herein to generate the risk-reward map, the belief, and/or otherwise insight data. In at least some implementations, one or more portions of the insight data may be tokenized (e.g., based upon a token sharing policy) to generate tokenized insight data. In one example, the insight data may be natively output (e.g., by an associated model, subsystem, etc.) as tokenized insight data. In another example, the insight data may be provided as an input to the data tokenizer generate the tokenized insight data, however, the tokenized insight data may be generated in any other suitable manner.

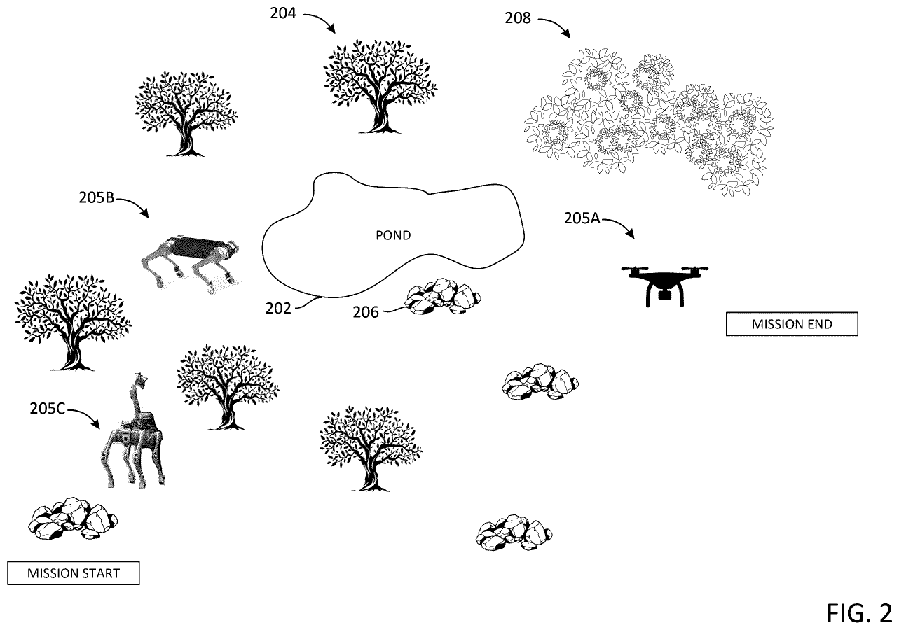

FIG. 2 depicts an example environment performing example real-time multi-robot collaboration, in one implementation of the instant application. The environment may include a fleet of robots configured to perform a mission that includes a drone 205A (e.g., the Robot A 105A) and a wheeled robot 205B (e.g., the Robot B 105B) of the fleet traveling from a mission start location to a mission end location. During the mission the drone 205A captures sensor data, generates insights from the sensor data, and performs actions based upon the insights in real-time. For example, when the drone 205A is located in a portion of the environment while flying over the pond 202, the drone captures sensor data that includes LIDAR point clouds and overhead images of a pond 202, a tree 204, rocks 206, and leaves 208. The drone 205A tokenized the sensor data for input into its RFM (e.g., the 106A), causing the drone 205A to generate insight data including risk-reward maps and beliefs associated with the portion of the environment. The drone may determine how to navigate to the mission end location, among other things, based up the insight data.

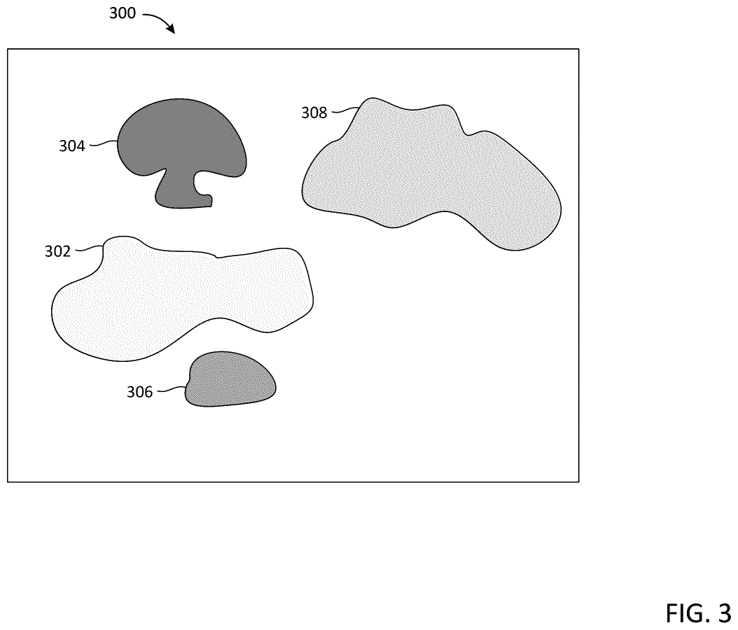

FIG. 3 depicts an example risk-reward map 300 (e.g., the risk-reward maps 110A) associated with the environment of FIG. 2, in one implementation of the instant application. The risk-reward map 300 may include heatmapping which depicts objects detected by the sensor data as gray objects in the risk-reward map 300, with darker shades of gray indicating objects having a great height than objects having a lighter shade of gray. Accordingly, the risk-reward map 300 indicates several objects of varying height including a highest object 304 shaded darkest gray (e.g., tallest object) corresponding to the tree 204, a second highest object 306 corresponding to the rocks 206, a third highest object 308 corresponding to the leaves 208, and a least highest object 302 corresponding to the pond 202. As the drone 205A is an aerial vehicle configured to fly across the environment, the drone 205A may generate a navigation path (e.g., the action 114A) to the mission destination that includes flying over terrain of the environment with no obstacles or obstacles having a low height. Selecting such a navigation path may be considered the “safest” navigation path from a risk-reward perspective as compared to flying near a tall object, such as the tree 204 indicated by the highest object 304 of the risk-reward map 300.

Returning to FIG. 1, the workflow 100 may include the Robot A 105A implementing a token sharing policy 116A and Robot B 105B implementing a token sharing policy 116B. The token sharing policy may indicate rules, guidelines, and/or other criteria used by an associated robot to identify tokenized data to share with one or more other robots, referred to herein at times as recipient robots, such as other robots in the fleet. For example, the token sharing policy may cause the robot to identify and/or otherwise select insight data to share with another robot (e.g., via robot-to-robot direct communication, via a communication network, etc.), tokenize the insight data (e.g., if not tokenized already), and/or share the tokenized insight data with another robot. The tokenized insight data may include and/or otherwise indicate a pose of the robot associated with a map (e.g., a pose of the robot when generating sensor data used to generate a risk-reward map), the tokenized sensor data used to generate the insight data, an area of the environment assigned to a robot for exploration, an area of the environment already explored by the robot, a boundary between an area of the environment explored by the robot and an area of the environment unexplored by the robot, a next area of the environment for exploration by the robot, a navigation path of the robot through the environment, and/or any other suitable information. Implementing the token sharing policy may cause the associated robot to tokenize all of its insight data, tokenize at least a portion of its insight data, refrain from tokening insight data, identify at least one robot (e.g., of the robot fleet) to receive the tokenized insight data, refrain from sharing tokenized insight data with at least one other robot, and/or any other suitable action. In response to receiving the tokenized insight data, recipient robot may analyze at least a portion of the tokenized insight data for (e.g., via the RFM for making the decisions associated with performing the mission), analyze none of the tokenized insight data for making the decisions associated with performing the mission, transmit the tokenized insight data to other robots, refrain from transmitting the tokenized insight data to other robots, and/or perform any other suitable action.

With simultaneous reference to FIGS. 2 & 3, the wheeled robot 205B may be located near the pond 202 and be ready to make a decision about which way to go around the pond 202. As the wheeled robot 205B is a terrestrial-based robot, it is unable to sense objects beyond the edge of the pond nearest to the wheeled robot 205B unlike the drone 205A which is able to fly across the pond 202. Due to such a limitation, the wheeled robot 205B is therefore unaware of the tree 204, the rocks 206 and the leaves 208 based upon its own sensor data. Accordingly, any decision by the wheeled robot 205B associated with a path to travel around the pond 202 would be based upon limited information as compared to also having the knowledge of the sensor data of the drone 205A.

Based upon its token sharing policy (e.g., the token sharing policy 116A), the drone 205A may transmit its tokenized insight data that includes the risk-reward map 300 to the wheeled robot 205B. The drone 205A may perform a broadcast of the tokenized insight data such that any device within range can receive the tokenized insight data, for example receiving tokenized data that is encrypted and having a suitable decryption mechanism to decrypt it for security. The drone 205A may perform a targeted, robot-to-robot wireless communication of tokenized insight data the to the wheeled robot 205B, and/or transmit they tokenized insight data in any other suitable manner to the wheeled robot 205B and/or other recipient robots. The wheeled robot 205B may receive the drone's tokenized insight data that includes the risk-reward map 300. Upon processing the tokenized insight data (e.g., via its RFM 106B) the wheeled robot 205B is now aware of the least highest object 302, the highest object 304, the second highest object 306, and the third highest object 308 indicated by the tokenized insight data. As the wheeled robot 205B is terrestrial based and travels using its wheels, the safest path of travel for the wheeled robot 205B is over land with a minimal height profile.

The wheeled robot 205B may input its own sensor data, along with tokenized insight data received from the drone 205A, into its RFM to generate risk-reward maps, beliefs, and/or other information associate with making decisions. Based upon the tokenized insight data of the drone 205A, the wheeled robot 205B can now make a more informed navigation regarding how to travel around the pond, and/or other actions. For example, the wheeled robot's own sensor data may identify the pond 202 as a water object which the wheeled robot 205B cannot travel across, the result of which is the wheeled robot 205B does not consider traveling across the least highest object 302 of the drone's tokenized sensor data. For example, the drone's tokenized sensor data may indicate the pose of the drone 205A (e.g., an aerial view) when generating the risk-reward map 300 such that the wheeled robot 205B is able to understand the pond 202 is the same object in its own sensor data as the least highest object 302 in the drone's risk-reward map 300, and cause the wheeled robot 205B to avoid traveling toward the least highest object 302. Instead, the wheeled robot 205B makes a decision (e.g., the action 114B) to travel toward the third highest object 308 corresponding to the leaves 208 rather than the second highest object 306, as this would be considered the safest route since the third highest object 308 has the smallest height profile of all objects besides the pond based upon the drone's tokenized insight data. Advantageously, by avoiding the second highest object 306 corresponding to the rocks 206, the wheeled robot 205B avoids traveling toward the rocks which it would be unable to travel across, but rather travels towards the leaves 208 which it can travel across to reach the mission end location. Accordingly, by sharing its tokenized insight data, the drone 205A allows the wheeled robot 205B to improve its performance during the mission and make informed decisions it would otherwise be unable to make with the drone's tokenized insight data. Further, by first tokenizing the insight data, the data can be compressed to require fewer computing resources (e.g., memory, network bandwidth/capacity, etc.) to store, process (e.g., via a processor) and/or transmit the tokenized insight data as compared to the non-tokenized insight data.

It should be understood that although the workflow 100 is described as being performed by two robots 105A, 105B, the workflow 100 may be performed between multiple robots beyond two robots. For example, FIG. 3 depicts a third robot 205C that is a legged terrestrial robot. Such a robot has different locomotive capabilities than the drone 205A (e.g., which can fly) and the wheeled robot 205B which travels via wheels. For example, the third robot 205C cannot travel aerially across the pond 202, but can travel across the rocks 206 due to the ability provided by its legs. Accordingly, its considerations for making decisions (e.g., the actions 114A, 114B) may differ from the drone 205A and/or the wheeled robot 205B. The wheeled robot 205B may implement its token sharing policy (e.g., the token sharing policy 116B) to determine whether to share its own insight data with the drone 205A and/or third robot 205C, as well as whether to share the tokenized insight data of the drone 205A with the third robot 205C. In at least some implementations, implementing its token sharing policy may cause the wheeled robot 205B to generate a tokenized insight dataset by tokenizing its own insight data, and transmitting to the third robot 205C tokenized insight data that includes its own tokenized insight datasets and a second tokenized insight dataset that includes the drone's tokenized insights data. The third robot 205C may receive the tokenized insight data from the wheeled robot 205B and understand where the drone 205A and wheeled robot 205B have already traveled in the environment, what areas may be left to explore, etc., when making decisions. Accordingly, the inventive techniques allow the third robot 205C to implement an already risk-constrained RFM and provide further safe operation by weighting risks and rewards associated with characteristics of the environment previously unknown to the third robot 205C in light of the particular capabilities of the third robot 205C. Such improvements in the technical field of real-time multi-robot collaboration data sharing may cause the third robot 205C to travel across the rocks 206 rather than traveling around the pond over the leaves 208, thereby using the safest and shortest route to reach the mission end location.

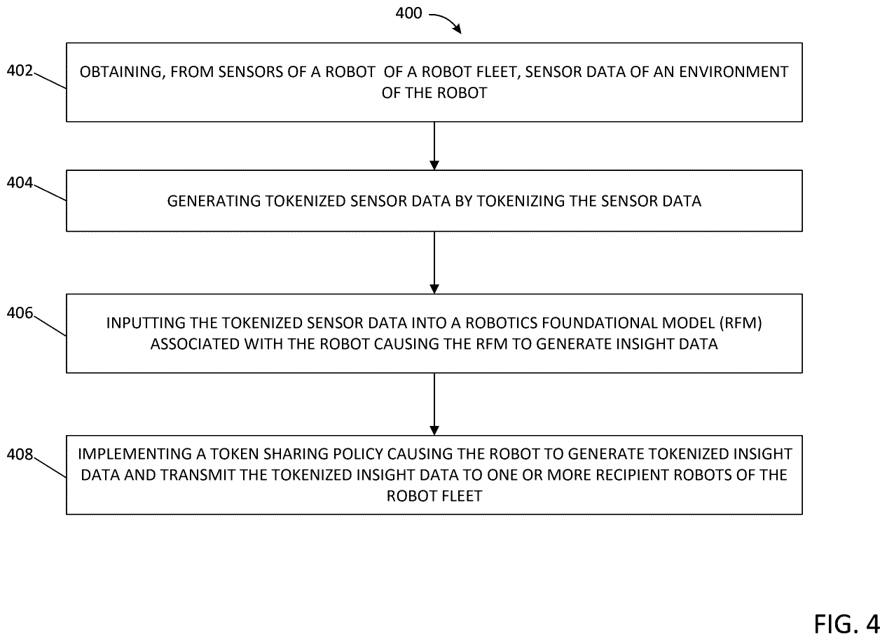

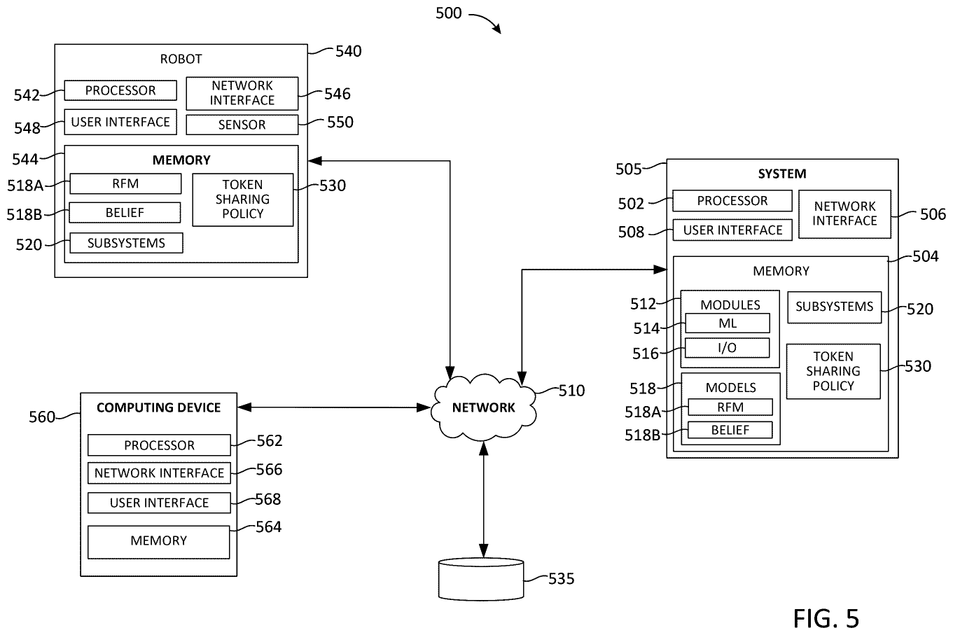

FIG. 4 is a flow diagram depicting an example computer-implemented method 400 for performing real-time multi-robot collaboration in dynamic environments, in one implementation of the instant application. One or more steps of the computer-implemented method 400 may be implemented as a set of instructions stored on a computer-readable memory and executable via one or more local or remote processors, and/or other electronic or electrical components, which may be in wired or wireless communication with one another, such as those depicted in FIG. 5 The computer-implemented method 400 may include obtaining, from sensors of a robot (e.g., the Robot A 105A) of a robot fleet, sensor data (e.g., the sensor data 102A) of an environment of the robot (block 402). The robot fleet may be configured to perform a mission in the environment unknown to the robot fleet. The sensors may include one or more of: an imaging sensor, a navigation sensor, or a proprioception sensor.

The computer-implemented method 400 may include generating tokenized sensor data by tokenizing (e.g., via the data tokenizer 104A) the sensor data (block 404).

The computer-implemented method 400 may include inputting the tokenized sensor data into a robotics foundational model (RFM) (e.g., the RFM 106A) associated with the robot causing the RFM to generate insight data (block 406). The insight data may be used by the robot for making decisions associated with performing the mission.

Generating the insight data (block 406) may include generating, via a belief model based upon the tokenized sensor data, belief data indicating one or more beliefs about the environment. The one or more beliefs may be associated with one or more of: a pose of the robot in the environment, a type of object in the environment, a location of an object in the environment, a navigation path of the environment, or whether a portion of the environment has been explored by the robot fleet. The belief data may indicate a portion of the environment associated with a belief and a confidence metric associated with the belief. Generating the belief data may include calculating, via the belief model based upon the tokenized sensor data, probability distributions associated with characteristics of the environment, wherein the one or more beliefs are based at least in part upon the probability distributions. The belief model may include one or more of: a localization belief model, a mapping belief model, and planning belief model.

Generating the insight data (block 406) may include generating one or more risk-reward maps (e.g., the risk-reward map 300). Each risk-reward map may indicate one or more of a potential risk or a potential reward associated with the robot performing the mission, wherein the insight data includes the belief data and the one or more risk-reward maps. The one or more risk-reward maps may include one or more of: a sematic map, a velocity map, a confidence map, a cost map, a risk map, a reward map, or an attention map.

The computer-implemented method 400 may include implementing a token sharing policy (e.g., the token sharing policy 116A) (block 408). Implementing the token sharing policy (block 408) may cause the robot to generate tokenized insight data (e.g., by tokenizing the insight data). Implementing the token sharing policy may cause the robot to tokenize all of the insight data, tokenize at least a portion of the insight data, or identify at least one robot of the robot fleet to receive the tokenized insight data. Generating the tokenized insight data may include compressing the insight data to generate the tokenized insight data. The tokenized insight data may indicate one or more of: a pose of the robot associated with a map, the tokenized sensor data used to generate the insight data, an area of the environment assigned for exploration by the robot, an area of the environment already explored by the robot, a boundary between an area of the environment explored by the robot and an area of the environment unexplored by the robot, a next area of the environment for exploration by the robot, or a navigation path of the robot in the environment. Implementing the token sharing policy (block 408) may cause the robot to transmit the tokenized insight data to one or more recipient robots of the robot fleet.

In at least some implementations, in response to receiving the tokenized insight data, the computer-implemented method 400 may include causing the one or more recipient robots to perform operations of one or more of: analyzing at least a portion of the tokenized insight data for making the decisions associated with performing the mission, analyzing none of the tokenized insight data for making the decisions associated with performing the mission, transmitting the tokenized insight data to other robots, or refraining from transmitting the tokenized insight data to other robots.

In at least some implementations of the computer-implemented method 400, the robot may be a first robot (e.g., the drone 205A), the tokenized insight data may be a first tokenized insight dataset, and the one or more recipient robots may include a second robot (e.g., the wheeled robot 205B) and a third robot (e.g., the third robot 205C). In some such implementation, the computer-implemented method 400 may include causing the second robot to implement a respective token sharing policy causing the second robot to perform operations of: generating second tokenized insight dataset by tokenizing insight data of the second robot, and transmitting, to the third robot, the tokenized insight data that includes the first tokenized insight dataset and the second tokenized insight dataset. The tokenized insight data may indicate one or more of: a robot type, an internal state, or an identifier of the robot associated with a tokenized insight dataset.

It should be understood that not all blocks of the exemplary flow diagram of FIG. 4 are required to be performed.

FIG. 5 is a block diagram depicting an example computing environment 500 for performing real-time multi-robot collaboration in dynamic environments, in one implementation of the instant application. The computing environment 500 may include a system 505 communicatively coupled, via a network 510, to a database 535, a robot 540, and a computing device 560. The computing environment 500 may be implemented, used, and/or configured to perform at least a portion of the workflow 100 and/or computer-implemented method 400. Although FIG. 5 depicts certain entities, components, equipment, and devices, it should be appreciated that fewer, additional and/or alternate entities, components, equipment, and/or devices may be envisioned.

The system 505 may perform functionalities associated with performing real-time multi-robot collaboration in dynamic environments, such as obtaining data (e.g., sensor data), configuring the robot 540, training and/or implementing a model (e.g., a machine learning model), etc. The system 505 may include, and or be part of, a cloud network or may otherwise communicate with other hardware or software components within one or more cloud computing environments to send, retrieve, or otherwise analyze data or information described herein. For example, in certain aspects of the present techniques, the computing environment 500 may include an on-premise computing environment, a multi-cloud computing environment, a public cloud computing environment, a private cloud computing environment, and/or a hybrid cloud computing environment. For example, an entity (e.g., a robotics company) may host one or more services in a public cloud computing environment (e.g., Alibaba Cloud®, Amazon Web Services® (AWS), Google Cloud®, IBM Cloud®, Microsoft Azure®, etc.). The public cloud computing environment may be a traditional off-premise cloud (i.e., not physically hosted at a location owned/controlled by the entity). Alternatively, or in addition, aspects of the public cloud may be hosted on-premises at a location owned/controlled by the entity. The public cloud may be partitioned using visualization and multi-tenancy techniques and may include one or more infrastructure-as-a-service (IaaS) and/or platform-as-a service (PaaS) services.

The system 505 may include at least one processor 502. The processor 502 may include one or more computational circuits, including, but not limited to, one or more central processing units (CPUs), microprocessor units, microcontrollers, complex instruction set computing (CISC) microprocessor units, reduced instruction set computing microprocessor (RISC) units, very long instruction word microprocessor units, explicitly parallel instruction computing microprocessor units, graphics processing units (GPUs), digital signal processing (DPS) units, or any other type of processing circuit. The processor 502 may also include embedded controllers, such as generic or programmable logic devices or arrays, application-specific integrated circuits (ASICs), single-chip computers, and the like. The processor 502 may be connected to a memory 504 via a computer bus (not depicted) responsible for transmitting electronic data, data packets, and/or otherwise electronic signals to and from the processor 502 and the memory 504 in order to implement or perform the machine-readable instructions, methods, processes, elements, or limitations, as illustrated, depicted, or described for the various flowcharts, illustrations, diagrams, figures, and/or other disclosure herein. The processor 502 may interface with the memory 504 via a computer bus to execute an operating system and/or computing instructions contained therein, and/or to access other services/aspects. For example, the processor 502 may interface with the memory 504 via the computer bus to create, read, update, delete, or otherwise access or interact with the data stored in the memory 504 and/or the database 535.

The system 505 may include at least one network interface 506. The network interface 506 may allow the system 505 to communicate over the network 510, for example via any suitable wired and/or wireless connection. The network interface 506 may include one or more hardware, firmware, and/or software components (e.g., Ethernet cards, Wi-Fi adapters, cellular modems). The network interface 506 may include one or more transceivers (e.g., wireless wide area network (WWAN), wireless local area network WLAN, and/or wireless personal area network (WPAN) transceivers) functioning in accordance with IEEE® standards, 3GPP® standards, and/or other standards, and that may be used in receipt and transmission of data (e.g., via external/network ports connected to the network 510).

The system 505 may include at least one user interface 508. The user interface 508 may include one or more components and/or devices to receive an input and/or generate an output. The user interface 508 may include one or more of a keyboard, a mouse, a display (e.g., liquid crystal display (LCD), organic light-emitting diode (OLED) display), a touchscreen, a microphone, a speaker, an imaging device, a button, a switch, and/or other suitable components or device for to receiving an input and/or generating an output.

The memory 504 may include one or more forms of volatile and/or non-volatile, fixed and/or removable memory, such as read-only memory (ROM), electronic programmable read only memory (EPROM), random access memory (RAM), erasable electronic programmable read-only memory (EEPROM), compact disks, digital video disks, diskettes, magnetic tape cartridges and/or other hard drives, flash memory, MicroSD® cards, and others. The memory 504 may store an operating system (e.g., Microsoft Windows®, Linux®, UNIX®, etc.) capable of facilitating the functionalities, apps, methods, or other software as discussed herein. In general, a computer program or computer based product, application, or code (e.g., ML models or other computing instructions described herein) may be stored on a machine-readable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 502 (e.g., working in connection with the respective operating system in memory 504) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang®, Python®, C®, C++®, C #®, Objective-C®, Java®, Scala®, ActionScript®, JavaScript®, HTML®, CSS®, XML®, etc.).

The memory 504 may store at least one computing module 512. The computing module 512 may be implemented as respective sets of computer-executable instructions (e.g., one or more source code libraries) as described herein. A component or device (standalone, client or distributed computer or computing system) configured by an application may constitute a computing module 512, also referred to herein at times interchangeably as a “subsystem” or “module,” that is configured and operated to perform certain operations. In one implementation, the computing module 512 may be implemented mechanically or electronically. The computing module 512 may include dedicated circuitry or logic that is permanently configured (within a special-purpose processor) to perform certain operations. In another implementation, the computing module 512 may also include programmable logic or circuitry (as encompassed within a general-purpose processor or other programmable processor) that is temporarily configured by software to perform certain operations. Accordingly, the term computing module 512 should be understood to encompass a tangible entity, be that an entity that is physically constructed permanently configured (hardwired) or temporarily configured (programmed) to operate in a certain manner and/or to perform certain operations described herein.

The computing module 512 may include an ML module 514. The ML module 514 may perform ML model training and/or operation. In at least some implementations, at least one of a plurality of ML methods and algorithms may be applied by the ML module 514, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various implementations, the implemented ML methods and algorithms are directed toward at least one of a plurality of categorizations of ML, such as supervised learning, unsupervised learning, and reinforcement learning. In one aspect, the ML based algorithms may be included as a library or package executed on the system 505. For example, libraries may include the TensorFlow® based library, the PyTorch® library, and/or the scikit-learn Python® library.

In one implementation, the ML module 514 employs supervised learning, which involves identifying patterns in existing data to make predictions about subsequently received data. Specifically, the ML module 514 is “trained” using training data, which includes exemplary inputs and associated exemplary outputs. Based upon the training data, the ML module 514 may generate a predictive function which maps outputs to inputs and may utilize the predictive function to generate ML outputs based upon data inputs. The exemplary inputs and exemplary outputs of the training data may include any of the data inputs or ML outputs described above. In the exemplary implementations, a processing element may be trained by providing it with a large sample of data with known characteristics or features.

In another implementation, the ML module 514 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 514 may organize unlabeled data according to a relationship determined by at least one ML method/algorithm employed by the ML module 514. Unorganized data may include any combination of data inputs and/or ML outputs as described above.

In yet another implementation, the ML module 514 may employ reinforcement learning, which involves optimizing outputs based upon feedback from a reward signal. Specifically, the ML module 514 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 514 may include a set of computer-executable instructions implementing ML training (e.g., model creation, fine-tuning, retraining, etc.). The ML module 514 may access one or more repositories (e.g., the database 535) or any other data source for training data suitable to generate and/or otherwise train one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 514 at runtime to process input data and generate output data.

The ML module 514 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The ML module 514 may include a set of computer-executable instructions implementing ML loading, configuration, initialization and/or operation functionality. The ML module 514 may include instructions for storing trained models (e.g., in the database 535). Once trained, the one or more trained ML models may be operated in inference mode, whereupon when provided with de novo input that the model has not previously been provided, the model may output one or more predictions, classifications, etc., as described herein.

While various implementations, examples, and/or aspects disclosed herein may include training and generating one or more ML models for the system 505 to load at runtime, it is also contemplated that one or more appropriately trained ML models may already exist (e.g., stored in the database 535, on the robot 540) such that the system 505 may load an existing trained ML model at runtime. It is further contemplated that the system 505 may retrain, fine-tune, update and/or otherwise alter an existing ML model before and/or after loading the model at runtime. Accordingly, one device (e.g., the system 505) of the computing environment 500 may train the ML model while another device (e.g., the robot 540) may execute the ML model.

The computing module 512 may include an input/output (I/O) module 516, including a set of computer-executable instructions implementing communication functions. The I/O module 516 may include a communication component configured to communicate (e.g., send and receive) data via one or more external/network port(s) to one or more components (e.g., the user interface 508), networks (e.g., the network 510) devices (e.g., the robot 540 and/or the computing device 560) as described herein. I/O module 516 may further include or implement an operator interface configured to present information to an administrator or operator and/or receive inputs from the administrator and/or operator (e.g., via the user interface 508). The I/O module 516 may facilitate I/O components (e.g., ports, capacitive or resistive touch sensitive input panels, keys, buttons, lights, LEDs), which may be directly accessible via, or attached to, the system 505 or may be indirectly accessible via or attached to another device (e.g., the computing device 560).

The memory 504 may include at least one machine learning (ML) model 518. The ML model 518 may include one or more routines, functions, algorithms, ML models, and/or other element(s) stored in memory 504. The ML model 518 may be referred to as receiving an input, producing or storing an output, or executing, the routine, model, or other element. The ML model 518 may be executing as instructions on the processor 502. Further, those of skill in the art will appreciate that the ML model 518 be stored in the memory 504 as executable instructions, which instructions the processor 502 may retrieve from the memory 504 and execute. Further, the processor 502 should be understood to retrieve from the memory 504 any data necessary to perform the executed instructions (e.g., data required as an input to ML model 518), and to store in the memory 504 the intermediate results and/or output of any executed instructions.

The ML model 518 may include a robotics foundation model 518A (RFM) (e.g., the RFM 106A). The RFM 518A may provide a general-purpose foundation for robotic perception, reasoning, and action. The functionality of the robot 540 may be implemented, controlled, and/or otherwise provided by the associated RFM 518A. The RFM 518A may be based on one or more large-scale machine learning architectures. The RFM 518A may be risk-constrained foundation model configured to ensure safety is a key consideration in the decisions made by the RFM 518A and/or otherwise robot 540.

The ML model 518 may include a belief model 518B. The belief model 518B may generate the belief data based upon receiving sensor data (e.g., tokenized sensor data) as an input. The belief model 518B may include and/or implement one or more models, such as a localization belief model (e.g., to generate beliefs associated with localization of the robot), a mapping belief model (e.g., to generate beliefs associated with a location of the robot), a planning belief model (e.g., to generate beliefs associated with planning tasks of a mission of the robot), and/or any other suitable belief model. In some such implementations, the robot may provide the tokenized sensor data to one or more belief models to generate the beliefs data. The belief model 518B may be configured to calculate probability distributions to estimate various aspects of the environment, such as the likelihood of encountering the obstacles or changes in the terrain.

The memory 504 may include one or more subsystems 520. The subsystems 520 may configured to perform one or more functions associated with performing real-time multi-robot collaboration, as further described herein.

The memory 504 may store a token sharing policy 530 (e.g., the token sharing policy 116A). The token sharing policy 530 may indicate rules, guidelines, and/or other criteria used by an associated robot to identify tokenized data to share with one or more other robots, referred to herein at times as recipient robots, such as other robots in the fleet.

The network 510 may generally enable bidirectional communication between devices and/or components of the computing environment 500 (e.g., the system 505, the database 535, the robot 540, and/or the computing device 560). The network 510 may be, and/or include, one or more wired communication networks and/or a wireless communication networks. The wired communication network may include one or more Ethernet connections, Fiber Optics, Power Line Communications (PLCs), Serial Communications, Coaxial Cables, Quantum Communication, Advanced Fiber Optics, Hybrid Networks, and the like. The wireless communication network may include one or more of wireless fidelity (Wi-Fi), cellular networks (e.g., fourth generation (4G), fifth generation (5G), sixth generation (6G), Bluetooth®, ZigBee®, long-range wide area network (LoRaWAN), satellite communication, radio frequency identification (RFID), internet-of-things (IoT) networks, mesh networks, non-terrestrial networks (NTNs), near field communication (NFC), and the like. The network 510 may include any suitable network or networks, including a local area network (LAN), wide area network (WAN), Internet, and/or combination thereof. In one aspect, the network 510 may include a cellular base station, such as cellular tower(s), communicating to the one or more components of the computing environment 500 via wired/wireless communications based upon any one or more of various mobile phone standards, including Global System for Mobile Communications® (GSM), Code Division Multiple Access® (CDMA), Universal Mobile Telecommunications System® (UMTS), Long Term Evolution® (LTE), Ultra-wideband® (UWB), and/or the like. Additionally, or alternatively, the network 510 may include one or more routers, wireless switches, or other such wireless connection points communicating to the components of the computing environment 500 via wireless communications based upon any one or more of various wireless standards, including by non-limiting example, IEEE® 702.11 a/ac/ax/b/c/g/n (Wi-Fi), Bluetooth®, and/or the like.

The computing environment 500 may include the database 535. The database 535 may be a relational database, such as Oracle®, DB2®, MySQL®, a NoSQL® based database, such as MongoDB®, or another suitable database. The database 535 may store data and/or datasets include one or more types of data, records, files, etc., however, the terms “data” and “dataset” may be used interchangeably herein. In at least some implementations, the database 535 may store and/or manage data related to performing real-time multi-robot collaboration, such as sensor data, insight data, token sharing policies, tokenized data, etc. The database 535 may provide efficient data retrieval, enabling real-time analysis to support decision-making processes of the robot 540. For example, the database 535 may be configured to store model training data, the ML models 518, robot configuration data, robot operational data, and/or another suitable data. It should be understood that data stored in the database 535 may be stored in one or more other suitable storage components (e.g., one or more of the memories 504, 544, 564). One or more components and/or devices of the computing environment 500 (e.g., the system 505, robot 540, the computing device 560) may access the database 535 (e.g., using the subsystems 520) via the network 510. The database 535 may manage user access controls, configuration settings, and system logs, and may provide a comprehensive solution for data management and a security within the computing environment 500.

The robot 540 may be configured to perform one or more tasks within an environment, such as real-time multi-robot collaboration. The robot 540 may be, or include, one or more off a quadruped, a wheeled robot, a biped, a drone, an unmanned arial vehicle (UAV), or an unmanned terrestrial vehicle (UTV), and/or any other suitable robot. The robot 540 may include a processor 542 (e.g., the processor 502) a memory 504 (e.g., the memory 504), a network interface 546 (e.g., the network interface 506), and/or a user interface 548 (e.g., the user interface 508). The memory 544 may include the RFM 518A (e.g., to control operation of the robot 540), the belief model 518B, the subsystems 520, and/or the token sharing policy 530.

The robot 540 may include at least one sensor 550. The sensor 550 may include, but is not restricted to, one or more imaging sensors (e.g., camera, complementary metal-oxide-semiconductor (CMOS), light detection and ranging (LIDAR), radio detection and ranging (RADAR), infrared (IR)), chemical sensors (e.g., oxygen, carbon dioxide), pressure sensors, navigation sensors (e.g., global position system (GPS), inertial measurement unit (IMU)), gyroscopes, accelerometers), proprioceptive sensors, environmental sensors (e.g., humidity, temperature, wind, ultra-violet (UV)), and/or any other suitable sensor. The sensor 550 may capture sensor data that may indicate and/or otherwise be associated with sensing one or more characteristics of the physical environment of the robot 540 and/or the robot 540 itself.

The robot 540 may be configured to operate (e.g., navigate, perform tasks) autonomously without intervention (e.g., input, feedback, control, etc., from another device and/or user), semiautonomously with at least some intervention, and/or anything therebetween. For example, in implementations where the robot 540 may operate autonomously, the robot 540 may perform a mission by navigating through a physical test environment that requires the robot 540 to have an understating of its location, orientation, and/or pose within the environment and/or of the objects of the physical test environment proximate the robot 540. To perform the mission, the robot 540 may execute one or more of the ML models 518, the subsystems 520, and/or the token sharing policy 530, etc.

The computing environment 500 may include at least one computing device 560. The computing device 560 may include one or more user devices, mobile devices, smartphones, Personal Digital Assistants (PDAs), tablet computers, phablet computers, wearable computing devices, virtual reality (VR) devices, augmented reality (AR) devices, laptops, desktops, display interface panels, control panels, human machine interface panels, liquid crystal display (LCD) screens, light-emitting diode (LED) screens, and the like. The computing device 560 may include a processor 562 (e.g., the processor 502, 542) a memory 564 (e.g., the memory 504, 544), a network interface 566 (e.g., the network interface 506, 546), a user interface 568 (e.g., the user interface 508, 548). In at least some implementations, the \computing device 560 may allow a user to provide input associated with performing real-time multi-robot collaboration, such as providing input associated with configuring the robot 540 for performing token sharing, etc.

The computing environment 500 may include additional, fewer, and/or alternate components, and may be configured to perform additional, fewer, or alternate actions, including components/actions described herein. Although the computing environment 500 is shown in FIG. 5 as including one instance of various components such as the system 505, the database 535, the robot 540, and the computing device 560, various aspects include the computing environment 500 implementing any suitable number of any of the components shown in FIG. 5 and/or omitting any suitable ones of the components shown in FIG. 5. For example, model training data described as being stored in the database 535 may be stored in the memory 504 of the system 505 and therefore the database 535 may be omitted. Moreover, various aspects include the computing environment 500 including any suitable additional component(s) not shown in FIG. 5, such as but not limited to the exemplary components described above. Furthermore, it should be appreciated that additional and/or alternative connections between components shown in FIG. 5 may be implemented. As just one example, system 505 and the database 535 may be connected via a direct communication link (not shown in FIG. 5) instead of, or in addition to, via the network 510.

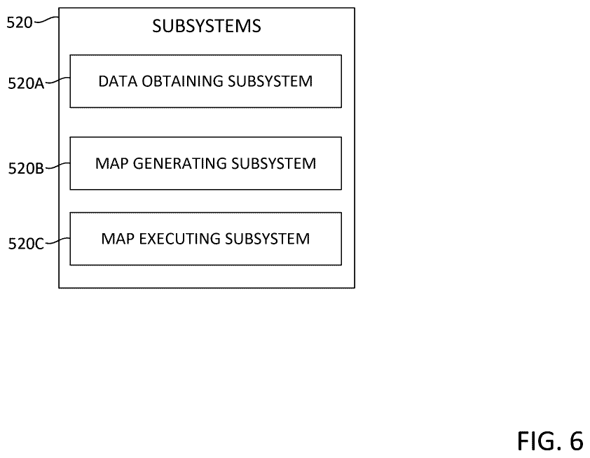

FIG. 6 is a block diagram depicting example subsystems 520 of the computing environment 500 of FIG. 5, in one implementation of the instant application. A data obtaining subsystem 520A may be configured to obtain sensor data from one or more sensors 550, tokenize the sensor data, store the sensor data, etc.

A map generating subsystem 520B may be configured to process the sensor data and/or insight data, for example by tokenizing the sensor data and/or the insight data, generating actionable insights (e.g., risk-reward maps, beliefs, etc.) that guide decision-making based upon the sensor data, etc. The map generating subsystem 520B may implement the belief model 518B. The map generating subsystem 520B may implement risk-reward mapping for generating maps that illustrate the potential risks and rewards associated with different actions.

A map executing subsystem 520C may be configured to transform generated maps and internal beliefs into actions that one or more robots may perform. The map executing subsystem 520C may be configured to transform the generated risk-reward maps and the internal beliefs into the actions that the robot 540 may perform. The map executing subsystem 520C may be configured to analyze the risk-reward maps and the internal beliefs to decide a best course of action of the robot 540, such as choosing a safe path or adjusting behavior to avoid the obstacles. The decisions may be made by weighing the risks against potential rewards, ensuring that the robots 540 acts efficiently and safely in the environment. The map executing subsystem 520C may cause the robot 540 to share selective pieces of information (e.g., tokens) with other robots 540. The tokens may comprise useful data, such as current state of the robot 540, risk-reward maps, beliefs, etc. The token sharing may ensure the robot 540 having similar knowledge and can adapt based on the collective knowledge of robot fleet, leading to better overall performance.

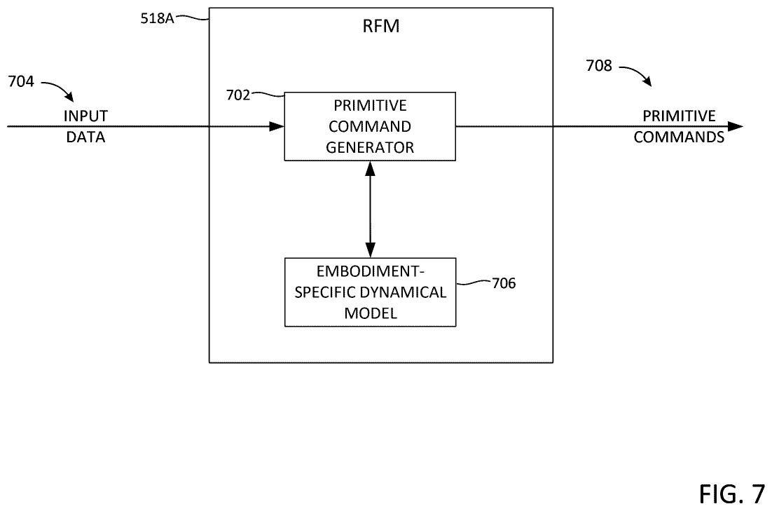

FIG. 7 is a block diagram of an example RFM 518A of the computing environment 500 of FIG. 5, in one implementation of the instant application. The RFM 518A may include a primitive command generator 702 that receives input data 704, such as sensor data and/or high-level mission instructions. The memory 504 may include explicit risk-reward features associated with performing the mission. The primitive command generator 702 may provide the input data 704 to the embodiment-specific dynamical model 706. The embodiment-specific dynamical model 706 may include a dynamical model that is configured for the specific embodiment of the robot 540, such as a wheeled robot, a biped, a drone. The embodiment-specific dynamical model 706 may map the explicit risk-reward features to commands used to control the robot 540. The controller (e.g., the processor 502) of the robot 540 may expose an application programming interface (API) that enables the primitive command generator 702 to issue primitive commands 708 to the robot 540 to control the operation of the robot 540. The level of granularity of control over the robot 540 (e.g., actuable components of the robot 540) can vary depending upon the specific embodiment. For example, the actuable components may include motors, servos, or other such elements that can control various elements of the robot 540. These elements can be used to navigate through the environment and/or interact with the environment, such as a physical testing environment. The robot 540 may include the API that enables the primitive command generator 702 to provide the primitive commands 708 that have low level control over numerous aspects of the operation of the robot 540, while other robots 540 may provide an API that accepts higher level commands that are translated by the controller of the robot 540 into low level commands that are used to control the actuable components. Accordingly, the implementation-specific dynamical model 706 may be configured to understand the specific API data receive via the API provided by the specific embodiment of the robot 540 to generate the correct primitive commands 708 for that API based on the high-level mission instructions. A technical benefit of this approach is that the API data may be agnostic to the specific embodiment of the robot 540, enabling the RFM 518A to be utilized with numerous different robot 540 by selecting an appropriate embodiment-specific dynamical model 706 for the robot 540.

While various embodiments and/or implementations have been described, the description is intended to be exemplary, rather than limiting, and it is understood that many more embodiments and/or implementations are possible that are within the scope of the embodiments and/or implementations. Although many possible combinations of features are shown in the accompanying figures and discussed in this detailed description, many other combinations of the disclosed features are possible. Any feature of any embodiment and/or implementation may be used in combination with or substituted for any other feature or element in any other embodiment and/or implementation unless specifically restricted. Therefore, it will be understood that any of the features shown and/or discussed in the present disclosure may be implemented together in any suitable combination. Accordingly, the embodiments and/or implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for performing real-time multi-robot collaboration in dynamic environments, the system comprising:
one or more processors; and
one or more memories having stored thereon processor-executable instructions that, when executed by the one or more processors, cause the one or more processors to perform operations of:
obtaining, from sensors of a robot of a robot fleet, sensor data of an environment of the robot, wherein the robot fleet is configured to perform a mission in the environment that is unknown to the robot fleet;
generating tokenized sensor data by tokenizing the sensor data;
inputting the tokenized sensor data into a robotics foundational model (RFM) associated with the robot causing the RFM to generate insight data used for making decisions associated with performing the mission, wherein generating the insight data includes:
generating, via a belief model based upon the tokenized sensor data, belief data indicating one or more beliefs about the environment, wherein the belief data indicates a portion of the environment associated with a belief and a confidence metric associated with the belief; and
generating one or more risk-reward maps, each risk-reward map indicating one or more of a potential risk or a potential reward associated with the robot performing the mission, wherein the insight data includes the belief data and the one or more risk-reward maps; and
implementing a token sharing policy causing the robot to perform:
generating tokenized insight data by tokenizing the insight data; and
transmitting the tokenized insight data to one or more recipient robots of the robot fleet.

2. The system of claim 1, wherein:
the robot is a first robot;
the tokenized insight data is a first tokenized insight dataset;
the one or more recipient robots include a second robot and a third robot; and
the one or more memories further comprising instructions that, when executed by the one or more processors, cause the one or more processors to perform operations of causing the second robot to implement a respective token sharing policy causing the second robot to perform operations of:
generating second tokenized insight dataset by tokenizing insight data of the second robot; and
transmitting, to the third robot, the tokenized insight data that includes the first tokenized insight dataset and the second tokenized insight dataset.

3. The system of claim 2, wherein the tokenized insight data indicates one or more of: a robot type, an internal state, or an identifier of the robot associated with a tokenized insight dataset.

4. The system of claim 1, wherein the one or more memories further comprises instructions for generating the belief data that, when executed by the one or more processors, cause the one or more processors to perform operations of:
calculating, via the belief model based upon the tokenized sensor data, probability distributions associated with characteristics of the environment, wherein the one or more beliefs are based at least in part upon the probability distributions.

5. The system of claim 1, wherein the belief model includes one or more of: a localization belief model, a mapping belief model, and planning belief model.

6. The system of claim 1, wherein the one or more beliefs are associated with one or more of: a pose of the robot in the environment, a type of object in the environment, a location of an object in the environment, a navigation path of the environment, or whether a portion of the environment has been explored by the robot fleet.

7. The system of claim 1, wherein the one or more memories further comprises instructions for generating tokenized insight data that, when executed by the one or more processors, cause the one or more processors to perform operations of compressing the insight data to generate the tokenized insight data.

8. The system of claim 1, wherein the one or more risk-reward maps include one or more of: a sematic map, a velocity map, a confidence map, a cost map, a risk map, a reward map, or an attention map.

9. The system of claim 1, wherein the one or more memories further comprises instructions for implementing the token sharing policy that, when executed by the one or more processors, cause the one or more processors to cause the robot to perform operations of one or more of: tokenizing all of the insight data, tokenizing at least a portion of the insight data, or identifying at least one robot of the robot fleet to receive the tokenized insight data.

10. The system of claim 1, wherein the one or more memories further comprises instructions that, when executed by the one or more processors, cause the one or more processors to perform operations of in response to receiving the tokenized insight data, causing the one or more recipient robots to perform operations of one or more of: analyzing at least a portion of the tokenized insight data for making the decisions associated with performing the mission, analyzing none of the tokenized insight data for making the decisions associated with performing the mission, transmitting the tokenized insight data to other robots, or refraining from transmitting the tokenized insight data to other robots.

11. The system of claim 1, wherein the sensors include one or more of: an imaging sensor, a navigation sensor, or a proprioception sensor.

12. The system of claim 1, wherein the tokenized insight data indicates one or more of: a pose of the robot associated with a map, the tokenized sensor data used to generate the insight data, an area of the environment assigned for exploration by the robot, an area of the environment already explored by the robot, a boundary between an area of the environment explored by the robot and an area of the environment unexplored by the robot, a next area of the environment for exploration by the robot, or a navigation path of the robot in the environment.

13. A computer-implemented method for performing real-time multi-robot collaboration in dynamic environments, the computer-implemented method comprising:
obtaining, by one or more processors from sensors of a robot of a robot fleet, sensor data of an environment of the robot, wherein the robot fleet is configured to perform a mission in the environment that is unknown to the robot fleet;
generating, via the one or more processors, tokenized sensor data by tokenizing the sensor data;
inputting, by the one or more processors, the tokenized sensor data into a robotics foundational model (RFM) associated with the robot causing the RFM to generate insight data used for making decisions associated with performing the mission, wherein generating the insight data includes:
generating, by the one or more processors via a belief model based upon the tokenized sensor data, belief data indicating one or more beliefs about the environment, wherein the belief data indicates a portion of the environment associated with a belief and a confidence metric associated with the belief; and
generating, by the one or more processors, one or more risk-reward maps, each risk-reward map indicating one or more of a potential risk or a potential reward associated with the robot performing the mission, wherein the insight data includes the belief data and the one or more risk-reward maps; and
implementing a token sharing policy causing the robot to perform:
generating, by the one or more processors, tokenized insight data by tokenizing the insight data; and
transmitting, by the one or more processors, the tokenized insight data to one or more recipient robots of the robot fleet.

14. The computer-implemented method of claim 13, wherein:
the robot is a first robot;
the tokenized insight data is a first tokenized insight dataset;
the one or more recipient robots include a second robot and a third robot; and
the computer-implemented method further comprises causing, by the one or more processors, the second robot to implement a respective token sharing policy causing the second robot to perform:
generating, by the one or more processors, second tokenized insight dataset by tokenizing insight data of the second robot; and
transmitting, by the one or more processors to the third robot, the tokenized insight data that includes the first tokenized insight dataset and the second tokenized insight dataset.

15. The computer-implemented method of claim 13, wherein generating the belief data comprises:
calculating, by the one or more processors via the belief model based upon the tokenized sensor data, probability distributions associated with characteristics of the environment, wherein the one or more beliefs are based at least in part upon the probability distributions.

16. The computer-implemented method of claim 13, wherein the one or more beliefs are associated with one or more of: a pose of the robot in the environment, a type of object in the environment, a location of an object in the environment, a navigation path of the environment, or whether a portion of the environment has been explored by the robot fleet.

17. The computer-implemented method of claim 13, wherein the one or more risk-reward maps include one or more of: a sematic map, a velocity map, a confidence map, a cost map, a risk map, a reward map, or an attention map.

18. The computer-implemented method of claim 13, further comprising in response to receiving the tokenized insight data, causing, by the one or more processors, the one or more recipient robots to perform operations of one or more of: analyzing at least a portion of the tokenized insight data for making the decisions associated with performing the mission, analyzing none of the tokenized insight data for making the decisions associated with performing the mission, transmitting the tokenized insight data to other robots, or refraining from transmitting the tokenized insight data to other robots.

19. The computer-implemented method of claim 13, wherein the tokenized insight data indicates one or more of: a pose of the robot associated with a map, the tokenized sensor data used to generate the insight data, an area of the environment assigned for exploration by the robot, an area of the environment already explored by the robot, a boundary between an area of the environment explored by the robot and an area of the environment unexplored by the robot, a next area of the environment for exploration by the robot, a navigation path of the robot in the environment, a robot type of the robot associated with a tokenized insight data, an internal state of the robot associated with a tokenized insight data, or an identifier of the robot associated with a tokenized insight data.

20. A non-transitory computer-readable medium storing processor-executable instructions that, when executed by one or more processors, cause the one or more processors to:
obtain, from sensors of a robot of a robot fleet, sensor data of an environment of the robot, wherein the robot fleet is configured to perform a mission in the environment that is unknown to the robot fleet;
generate tokenized sensor data by tokenizing the sensor data;
input the tokenized sensor data into a robotics foundational model (RFM) associated with the robot causing the RFM to generate insight data used for making decisions associated with performing the mission, wherein generating the insight data includes:
generating, via a belief model based upon the tokenized sensor data, belief data indicating one or more beliefs about the environment, wherein the belief data indicates a portion of the environment associated with a belief and a confidence metric associated with the belief; and
generating one or more risk-reward maps, each risk-reward map indicating one or more of a potential risk or a potential reward associated with the robot performing the mission, wherein the insight data includes the belief data and the one or more risk-reward maps; and
implement a token sharing policy causing the robot to perform:
generating tokenized insight data by tokenizing the insight data; and
transmitting the tokenized insight data to one or more recipient robots of the robot fleet.
